(19) United States
(12) Patent Application Publication
(10) Pub. No.: US 2009/0258667 A1
(43) Pub. Date: Oct. 15, 2009

(54) FUNCTION UNLOCKING SYSTEM, FUNCTION UNLOCKING METHOD, AND FUNCTION UNLOCKING PROGRAM

(75) Inventors: Tetsuaki Suzuki, Tokyo (JP); Atsushi Sato, Tokyo (JP); Hitoshi Imaoka, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/226,277

(22) PCT Filed: Apr. 13, 2007
(86) PCT No.: PCT/JP2007/058160

§ 371 Date: Oct. 14, 2008

(30) Foreign Application Priority Data
Apr. 14, 2006 (JP) 2006-112496

(51) Int. Cl. H04M 1/00; G05B 19/00

(52) U.S. Cl. 455/550.1; 340/5.53

(57) ABSTRACT

There is provided a function unlocking system using highly-convenient face authentication with high accuracy for an information processing terminal. In the function unlocking system, a face authentication section carries out face authentication by using a face image of the user that is obtained by an image pickup section, with key input carried out by the user through a key input section as a trigger. Along with the above, a key input content determination section determines whether a pattern of input key input matches with a pattern registered in advance or not. Then, an unlocking determining section determines whether a lock is to be released or not on the basis of a result of the face authentication by the face authentication section and a result of key input determination by a key input content determination section. In case the unlocking determining section determines that a lock is to be released, a function locking section releases the lock.

### TECHNICAL FIELD

The present invention relates to a function unlocking system, a function unlocking method, and a function unlocking program that release a locking state of an information processing terminal. In particular, the present invention relates to a function unlocking system, a function unlocking method, and a function unlocking program that release a locking state by using a plurality of authentication systems.

### BACKGROUND ART

For example, for releasing a locking state of an information processing terminal by using face authentication, there is an unlocking function using a screen saver as described in Non-Patent Document 1. The unlocking function using a screen saver descried in Non-Patent Document 1 is a function that starts a screen saver when the user of a personal computer (PC) does not carry out any operation with respect to the PC for a certain period of time, so as to conceal information displayed on a screen and disable input interfaces such as a keyboard and a mouse. In order to restart the PC, the user uses a camera attached to the PC that is started at all the time to take an image of a face to carry out face authentication while a screen saver is started. In this manner, a locking function by the screen saver is released.

In addition, Non-Patent Document 2 describes an operation method of a portable telephone device applied with a function unlocking system using face authentication. A processing flowchart of the portable telephone device shown in the operation method described in Non-Patent Document 2 is shown in FIG. 8.

As shown in FIG. 8, when the user presses an unlocking key (Step C1), the portable telephone device described in Non-Patent Document 2 starts face authentication processing, and executes face authentication by using a registered image that is obtained by picking up an image of the face of the user in advance (Step C2). As a result of the face authentication, in case a person (registered person) of the registered image and the user (person to be authenticated) currently in front of a camera are determined to be not the same person (No in Step C3), a lock is not released, and the processing ends as it is. On the other hand, as a result of the face authentication, in case the registered person and the user are determined to be the same person (Yes in Step C3), input of a personal identification number is further required (Step C4). The portable telephone device determines whether a personal identification number being input and a personal identification number registered in advance match with each other. In case the personal identification numbers do not match with each other (NG in Step C5), the lock is not released and the processing ends as it is. On the other hand, in case the personal identification numbers match with each other (OK in Step C5), the lock is released and processing ends (Step C6).

Moreover, Patent Document 1 describes a personal authentication device that intermittently executes personal authentication while in use, in order to prevent unauthorized access by switching of the user using the device, and the like. In addition, with respect to the personal authentication device described in Patent Document 1, there is suggested an example of combining a biometrics system using a face image and a key input characteristic (for example, a timing) and a password system as an example of selectively executing personal authentication of a plurality of systems.

Patent Document 1: JP 2002-055956-A (Paragraphs 0031 to 0034)

Non-Patent Document 1: Suzuki, Masahiro, “Away Management System ‘FaceMonitor’ Face Detection and Face Verification Engine ‘NeoFace’”, IMAGE LAB, Issue of March, 2005, Japan, 2005, p. 54 to 57

Non-Patent Document 2: “Instruction Manuals of FOMAP901iS”, NTT DoCoMo, November, 2005, p. 342 to 344

### DISCLOSURE OF THE INVENTION

### Problems to be Solved by the Invention

First problem is that accuracy of correct unlocking is low when only face authentication is used for releasing a locking state. In face authentication processing, a false acceptance rate that is a rate of accepting a person who is not registered as a registered person cannot be 0%. Also, when the false acceptance rate is lowered, a false rejection rate that is a rate of accepting a person who is registered as a registered person is also lowered as a characteristic of face authentication processing. In addition, when an environment of picking up an image or orientation of a face of a person to be authenticated is different from those at the time of registering a registered person, authentication accuracy tends to be lowered. For the above reason, authentication accuracy that is equivalent to that of, for example, a personal identification (PIN) code of four digits which is widely used for unlocking, is difficult to obtain. Accordingly, when only face authentication is used for releasing a locking state, accuracy of unlocking is determined only by accuracy of face authentication processing. Therefore, accuracy of unlocking is low as compared with unlocking using a PIN code.

A second problem is that power consumption is large when camera is activated at all the time, like a locking function using a screen saver as described in Non-Patent Document 1. In the locking function using a screen saver described in Non-Patent Document 1, since there is no method of identifying a timing that a person to be authenticated carries out unlocking, a camera used for unlocking needs to be activated at all the time. Accordingly, power consumption becomes large.

A third problem is that convenience to the user is degraded when accuracy of unlocking is improved by combining use of face authentication and other authentication, like the portable telephone device described in Non-Patent Document 2. The portable telephone device described in Non-Patent Document 2 requires the user to carry out input operation of a PIN code in addition to operation of pressing a button for starting face authentication in order to improve accuracy of unlocking. That is, the user is required to carry out a plurality of times of operation for unlocking, and this leads to loss of convenience to the user.

In addition, in case the personal authentication device described in Patent Document 1 is applied to a function unlocking system, convenience to the user can be improved by shortening time until when use is permitted in a manner that a plurality of personal authentication systems are executed selectively. However, when a positive result is obtained in a certain system and subsequent personal authentication is omitted, accuracy of unlocking is lowered. With respect to this point, the first problem applies to this case.

In view of the above, an object of the present invention is to provide a function unlocking system, a function unlocking method, and a function unlocking program that can achieve release of function locking with high accuracy without loss to convenience to the user.

### Means for Solving the Problems

A function unlocking system according to the present invention is a function unlocking system that releases a locking state which is a state where a function of an information processing terminal is locked, characterized by comprising: a face authentication means (for example, a face authentication means 33) for executing authentication processing by calculating a degree of coincidence on the basis of an image obtained by picking up an image of a user to be authenticated and face data indicating a characteristic of a face registered in advance; an authentication starting means (for example, a key input detecting means 31) for starting face authentication by the face authentication means when information input in accordance with operation by the user is detected; a pattern determining means (for example, a key input content determination means 32) for determining whether a pattern of user operation shown by the information detected by the authentication starting means matches with a pattern registered in advance or not; and an unlocking determining means (for example, an unlocking determining means 34) for determining whether the locking state of the information processing terminal is to be released or not on the basis of an authentication result of the face authentication means and a determination result of the pattern determining means.

In addition, a log image storing means (for example, a log image storing means 35) for storing an image that the face authentication means used for authentication as a log image may be included, in case the unlocking determining means determines that function locking is not to be released.

In addition, the face authentication means may include a face detecting means (for example, a face detecting means 331) for identifying a position of a face in an image, a face data creating means (for example, a face data creating means 332) for creating face data indicating a characteristic of the face on the basis of the position of the face identified by the face detecting means, and a face verifying means (for example, a face verifying means 333) for determining a degree of coincidence between the face data created by the face data creating means and face data registered in advance.

In addition, the log image storing means may store an image of a face area extracted on the basis of the position of the face identified by the face detecting means as a log image.

In addition, the authentication starting means may start face authentication by the face authentication means when information input in accordance with key input operation by the user is detected, and the pattern determining means may determine whether a pattern of key input indicated by the information detected by the authentication starting means matches with a key pattern registered in advance.

In addition, the key pattern used by the pattern determining means for determination may be a number of one digit, a character, or a function key.

In addition, the key pattern used by the pattern determining means for determination may be the same number, character, or function key that is repeated for a plurality of times.

In addition, the key pattern used by the pattern determining means for determination may be an input sequence of a number, characters, and function keys in a predetermined length.

In addition, the function unlocking system is a function unlocking system that releases a locking state which is a state where a function of an information processing terminal is locked, that may include: an authentication starting means (for example, the key input detecting means 31) for starting user authentication in a plurality of systems when information input in accordance with operation by the user is detected; a plurality of authentication executing means (for example, the key input content determining means 32 and the face authentication means 33) for executing authentication processing for determining whether the user carrying out operation is an authorized user permitted to use the information processing terminal or not by using a predetermined system; and an unlocking determining means (for example, the unlocking determining means 34) for determining whether the locking state of the information processing terminal is to be released or not on the basis of an authentication result of the plurality of authentication executing means started by the authentication starting means.

In addition, the unlocking determining means may determine that the locking state of the information processing terminal is to be released when all the authentication executing means started by the authentication starting means determine that the user to be authenticated is the authorized user.

In addition, the function unlocking method according to the present invention is a function unlocking method that releases a locking state which is a state where a function of an information processing terminal is locked, characterized by comprising: a starting step of picking up an image of a user to be authenticated when the information processing terminal detects information input in accordance with operation by the user; a face authentication step of executing authentication processing by calculating a degree of coincidence between the image obtained by picking up an image of the user to be authenticated and face data indicating a characteristic of a face registered in advance; a pattern determination step of determining whether a pattern of user operation indicated by the information detected by the starting step matches with a pattern registered in advance or not; and an unlocking determination step of determining whether the locking state of the information processing terminal is to be released or not on the basis of an authentication result of the face authentication step and a determination result of the pattern determination step.

In addition, the function unlocking method is a function unlocking method that releases a locking state which is a state where a function of an information processing terminal is locked, that may include: a step of starting user authentication in a plurality of systems when the information processing terminal detects information input in accordance with operation by the user; a plurality of steps of executing authentication processing for determining whether the user carrying out operation is an authorized user permitted to use the information processing terminal or not by using a predetermined system; and a step of determining whether the locking state of the information processing terminal is to be released or not on the basis of an authentication result of the plurality of systems.

In addition, the function unlocking program according to the present invention is a function unlocking program for releasing a locking state which is a state where a function of an information processing terminal is locked, the function unlocking program for controlling a computer to execute: starting processing for picking up an image of a user to be authenticated when information input in accordance with operation by the user is detected; face authentication processing for executing authentication processing by calculating a degree of coincidence between the image obtained by picking up an image of the user to be authenticated and face data indicating a characteristic of a face registered in advance; pattern determination processing for determining whether a pattern of user operation indicated by the information detected by the starting processing matches with a pattern registered in advance or not; and unlocking determination processing for determining whether the locking state of the information processing terminal is to be released or not on the basis of an authentication result of the face authentication processing and a determination result of the pattern determination processing.

In addition, the function unlocking program is a function unlocking program for releasing a locking state which is a state where a function of an information processing terminal is locked, the function unlocking program that may control a computer to execute: processing for starting user authentication in a plurality of systems when information input in accordance with operation by the user is detected; a plurality of processing for executing authentication processing for determining whether the user carrying out operation is an authorized user permitted to use the information processing terminal or not by using a predetermined system; and processing for determining whether the locking state of the information processing terminal is to be released or not on the basis of an authentication result of the plurality of systems.

### ADVANTAGES OF THE INVENTION

According to the present invention, when the user carries out specific operation, an authentication starting means executes, for example, face authentication and pattern authentication, and an unlocking determining means determines whether a function lock should be released or not on the basis of aggregating results of authentication functions in a plurality of systems. Accordingly, accuracy of unlocking can be improved as compared with a case where the above determination is carried out on the basis of one system. Also, through commonality of starting triggers of authentication functions in a plurality of systems, the user is not required to carry out input operation in accordance with such plurality of systems. Accordingly, unlocking with high accuracy can be executed without loss of convenience to the user.

### BRIEF DESCRIPTION OF THE DRAWINGS

FIG. 1 is a block diagram showing a configuration example of a function unlocking system according to a first exemplary embodiment of the present invention;

FIG. 2 is a block diagram showing a configuration example of a face authentication means used in the function unlocking system according to the first exemplary embodiment of the present invention;

FIG. 3 is a flowchart showing an operation example of the function unlocking system according to the first exemplary embodiment of the present invention;

FIG. 4 is a block diagram showing a configuration example of the function unlocking system according to a second exemplary embodiment of the present invention;

FIG. 5 is a flowchart showing an operation example of the function unlocking system according to the second exemplary embodiment of the present invention;

FIG. 6 is a block diagram showing a configuration example of the function unlocking system according to a third exemplary embodiment of the present invention;

FIG. 7 is an explanatory view showing a configuration example of a portable telephone device applied with the function unlocking system according to examples of the present invention; and

FIG. 8 is a flowchart showing an operation example of a portable telephone device applied with a function unlocking system using conventional face authentication.

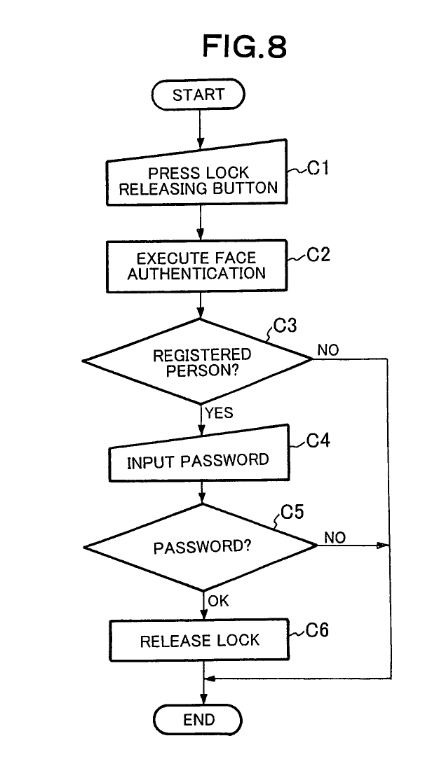

### EXPLANATION OF REFERENCE SYMBOLS

1: Key input means
2: Image pickup section
3: Data processing device
31: Key input detecting means
32: Key input content determining means
33: Face authentication means
34: Unlocking determining means
35: Log image storing means
4: Storage device
41: Key pattern storage section
42: Registered face data storage section
43: Release failure image storage section
5: Function locking section

### BEST MODE FOR CARRYING OUT THE INVENTION

### First Exemplary Embodiment

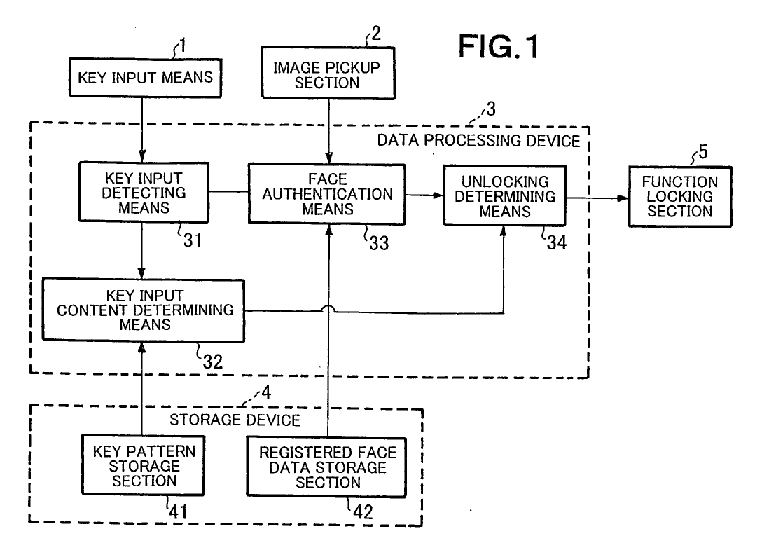

Hereinafter, a first exemplary embodiment of the present invention will be described with reference to the accompanying drawings. FIG. 1 is a block diagram showing a configuration example of a function unlocking system according to the present exemplary embodiment. The function unlocking system shown in FIG. 1 includes a key input means 1, an image pickup section 2, a data processing device 3, a storage device 4, and a function locking section 5. In addition, the data processing device 3 is a processing device, such as a CPU that operates in accordance with a program, and includes a key input detecting means 31, a key input content determining means 32, a face authentication means 33, and an unlocking determining means 34. Further, the storage device 4 is a memory and the like, and includes a key pattern storage section 41 and a registered face data storage section 42. More specifically, the unlocking system shown in FIG. 1 is achieved by an information processing terminal, such as a personal computer and a portable telephone device.

The key input means 1 is an input device operated by the user, such as a keyboard and a mouse. In case the present system is applied to a portable telephone device, the key input means 1 is an input device included in the portable telephone device, such as a numeric keypad, dialing buttons, and Neuropointer (registered trademark). The key input means 1 inputs key information in accordance with operation by the user. The key input means 1 is not limited only to a key input device. Accordingly, the key information here includes not only information (information of a pressed key, a pressing timing, a released timing, and the like) showing key operation, but also information (a timing of a click, a moving direction, a moving speed, coordinates of start and stop positions of a move, and the like) showing mouse operation, and information showing other input device information (for example, opening and closing operation).

The image pickup section 2 is an image input device, such as a CCD camera, a CMOD camera, and a video camera. The image pickup section 2 picks up an image of the face of the user and inputs the picked up image data in accordance with an instruction from the data processing device 3. Here, that the image pickup section 2 picks up an image of the face of the user means that the image pickup section 2 is controlled to pick up an image of the face of the user when a control parameter that is determined in advance in order to pick up, for example, an image of the face of a current operator is used. This does not necessarily mean that the face of the user requires to be picked up by the image pickup section 2.

The function locking section 5 controls a locking state by carrying out setting or release of locking with respect to an entire information processing terminal, and a specific function, such as display of information of a telephone book, a mail storage area, and the like. The function locking section 5 is achieved by a hardware device, such as a display device for locking a screen, that is used for achieving function locking, and a CPU that operates in accordance with a program. In FIG. 1, the function locking section 5 is shown as a processing section separate from the data processing device 3. However, there is also a case where the data processing device 3 includes the function locking section 5, for example, when function locking is performed only by software control.

The key pattern storage section 41 stores a key pattern that is set in advance for unlocking by key pattern determination. A key pattern (hereinafter referred to as the registered key pattern) stored in the key pattern storage section 41 is a combination of user operation shown by key information input from the key input means 1. Such key information is optionally set by a person that is permitted to use an information processing terminal. For example, the registered key pattern is a combination of key operation including the number of times, the order, a timing, and the like of pressing numbers from “0” to “9” and special letters such as “#” and “*” when the key input means 1 includes dialing buttons, or letters from “a” to “z”, numbers, and special letter keys such as “!” and “(” when the key input means 1 is a keyboard. In addition, for example, in case the key input means 1 includes a mouse, the above combination may include a timing of a click and a moving direction of the mouse. For example, a key pattern including a moving direction of the mouse may be motion of shaking the mouse to the left and the right twice in a manner of “right, left, right, left”, or movement that can be carried out by simple operation of drawing a circle in a clockwise direction with the mouse.

The registered face data storage section 42 stores face data of a registered image that is set in advance for unlocking by face authentication. Face data (hereinafter referred to as the registered face data) stored in the registered face data storage section 42 is image data of a registered image that is obtained by picking up an image of the face of a person who is permitted to use an information processing terminal, or data (for example, a characteristic amount) showing a characteristic of the face of a registered person created on the basis of such image data.

The key input detecting means 31 detects whether the user carries out input operation through the key input means 1 or not, and notifies such a fact to other processing means as needed. In the present exemplary embodiment, in case the key input detecting means 31 detects input operation by the user in a locking state, the key input detecting means 31 outputs such a fact at least to the key input content determining means 32 and the face authentication means 33.

Upon receiving the notification from the key input detecting means 31, the key input content determining means 32 carries out key pattern determination for determining whether an input key pattern and a registered key pattern are the same or not. In addition, the key input content determining means 32 outputs a result of the key pattern determination to the unlocking determining means 34.

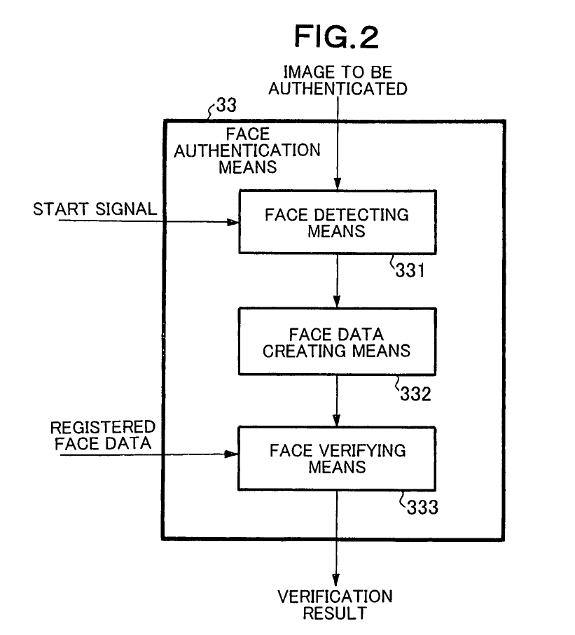

Upon receiving the notification from the key input detecting means 31, the face authentication means 33 starts the image pickup section 2, and carries out face authentication for determining whether a person who carries out input operation who is shown by an image input from the image pickup section 2 and a registered person are the same person or not. In addition, the face authentication means 33 outputs a result of the face authentication to the unlocking determining means 34. FIG. 2 is a block diagram showing a configuration example of the face authentication means 33. As shown in FIG. 2, the face authentication means 33 includes a face detecting means 331, a face data creating means 332, and a face verifying means 333.

The face detecting means 331 carries out face detection processing for identifying a position of a face in an image (image to be authenticated) input from the image pickup section 2. As the face detection processing carried out by the face detecting means 331, for example, high-speed face detection processing described in a document “Suzuki, Hosoi, Sakurai, and Sato, ‘Development of High-Speed Face Detection Processing Using Ring Filter’, Proceedings of The 2003 IEICE General Conference, p. 251” (Non-Patent Document 3) may be used. The high-speed face detection processing described in Non-Patent Document 3 is a face detection method for detecting a face in a manner described below. The high-speed face detection processing detects a candidate for an eye by using a ring filter that detects an area with a center section darker than a surrounding section as an eye. Then, the high-speed face detection processing determines whether a combination in the candidate of an eye is of a face of a person or not by using a dictionary that learned characteristics of a face in advance. The face data creating means 332 creates face data (hereinafter referred to as the face data to be authenticated) necessary for face verification from the image to be authenticated, on the basis of the position of the face identified by the face detecting means 331. The face verifying means 333 verifies the face data to be authenticated created by the face data creating means 332 against the registered face data stored in the registered face data storage section 42. In this manner, the face verifying means 333 determines whether a person who carries out input operation and a registered person are the same person or not.

The face data creating means 332 creates face data necessary for face verification used by the face verifying means 333. For example, the face verifying means 333 may use a verification method described in the document of “JP 2003-323622-A” (Patent Document 2). The verification method described in Patent Document 2 is a method in which an input face image is divided into a plurality of areas, and a similarity (distance between patterns) with a corresponding area in a face image registered in advance is obtained for each of the divided areas. Then, if an aggregate result of the obtained similarities is equal to or lower than a threshold value, persons in the two face images are recognized as the same person. In case the face verifying means 333 uses the verification method described in Patent Document 2, the face verifying means 333 creates, for example, a characteristic amount obtained by dividing the image to be authenticated into part sections as face data necessary for the method.

The unlocking determining means 34 determines whether a lock is to be released or not on the basis of a determination result from the key input content determining means 32 and a determination result from the face authentication means 33. More specifically, the unlocking determining means 34 determines to release a lock in case personal authentication is successful in both the key pattern determination by the key input content determining means 32 and the face authentication by the face authentication means 33. The unlocking determining means 34 determines that a lock is not to be released in case personal authentication is not successful in any of these.

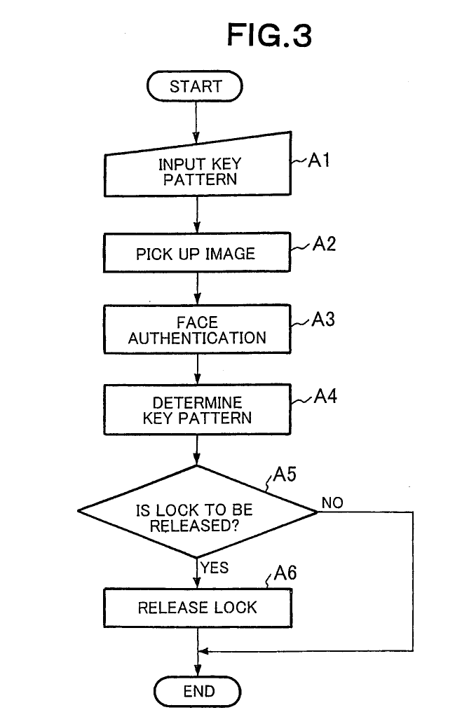

Next, description will be made with respect to operation of the present exemplary embodiment. FIG. 3 is a flowchart showing an operation example of the function unlocking system according to the present exemplary embodiment. Here, an information processing terminal applied with the function unlocking system is currently in a locking state. As shown in FIG. 3, an optional key pattern is first input through the key input means 1 by the user (person to be authenticated) (Step A1). The key input means 1 inputs key information in accordance with operation by the user. The key input detecting means 31 detects that the user has carried out input operation of a key pattern on the basis of key information input from the key input means 1. Upon detecting input operation of a key pattern by the user, the key input detecting means 31 outputs that fact to the key input content determining means 32 and the face authentication means 33. The key input detecting means 31, for example, may detect a series of input operation, and output a start signal of authentication operation including information indicating the input key pattern. A notification signal of key input including key information may be output to the key input content determining means 32 every time the key information is input.

Next, when the key input detecting means 31 detects that a key pattern is input, the face authentication means 33 starts and controls the image pickup section 2 to pick up a face image of the user (Step A2). The face authentication means 33, for example, receives a start signal from the key input detecting means 31, and outputs an instruction to pick up an image to the image pickup section 2, together with a control parameter that is set to include the face of the person to be authenticated. The image pickup section 2 picks up an image of the face of the user to be authenticated and inputs the picked-up image data, in accordance with the instruction from the face authentication means 33.

When image data is input from the image pickup section 2, the face authentication means 33 uses the image data to carry out face authentication (Step A3). For example, the face detecting means 331 identifies a position of a face in an image by using the input image data. Then, the face data creating means 332 creates face data (the face data to be authenticated) necessary for face verification from the input image, on the basis of the position of the face identified by the face detecting means 331. Then, the face verifying means 333 verifies the face data to be authenticated created by the face data creating means 332 against the registered face data stored in the registered face data storage section 42. In this manner, the face verifying means 333 determines whether the person to be authenticated and a registered person are the same person or not.

In addition, when the key input detecting means 31 detects that a key pattern is input, the key input content determining means 32 uses the input key pattern to carry out key pattern determination (Step A4). The key input content determining means 32, for example, receives a start signal or a notification signal from the key input detecting means 31, and determines whether an input key pattern shown by information input from the key input detecting means 31 and a registered key pattern stored in the key pattern storage section 41 are the same or not.

Next, the unlocking determining means 34 determines whether unlocking is permitted or not on the basis of a result of the face authentication obtained in Step A3 and a result of the key pattern determination obtained in Step A4 (Step A5). In case the face authentication means 33 determines that a person in the image to be authenticated and a person in a registered image are not the same person, or in case the key input content determining means 32 determines that an input key pattern and a registered key pattern are not same, the unlocking determining means 34 determines that unlocking is not permitted, and the processing ends as it is (No in Step A5).

On the other hand, in case the face authentication means 33 determines that a person in the image to be authenticated and a person in the registered image are the same person, and the key input content determining means 32 determines that an input key pattern and the registered key pattern are same, the unlocking determining means 34 determines that unlocking is permitted, outputs such a fact to the function locking section 5, and the function locking section 5 releases a lock (Step A6). For example, the function locking section 5 releases a lock by turning on a light of a display device in case the light of the display device is turned off so that a screen is not displayed, or by updating a locking state retained internally so that other processing sections carry out normal operation.

In FIG. 3, an example of carrying out processing in the order of image pickup (Step A2), face authentication (Step A3), and key pattern determination (Step A4). However, the processing may be carried out in any order as long as face authentication is executed after image pickup is carried out. In addition, face authentication and key pattern determination can be processed in parallel.

As described above, according to the present exemplary embodiment, whether unlocking is permitted or not is determined by aggregating results of two determinations, which are identified pattern determination and face authentication. Accordingly, accuracy of unlocking can be improved as compared with a case where unlocking is determined on the basis of one system. Also, by using key input which is a start trigger of identified pattern determination also as a start trigger of face authentication processing, unlocking with high accuracy can be executed without requiring the user to carry out key operation in accordance with a plurality of systems. Accordingly, an unlocking system with high accuracy can be achieved without loss of convenience to the user.

Since a start timing is not acquired from the user and the present exemplary embodiment drives the image pickup section 2 only when necessary, power consumption can be restricted as compared with a case where a camera device and the like are driven at all the time.

In addition, in case a failure factor is not notified to the person to be authenticated, assumption of a proper authentication method can be made difficult for a person attempting unauthorized access. Such a person attempting unauthorized access is not notified of a failure factor, and therefore this person cannot judge in which system the person committed a failure. In this manner, assumption of the registered key pattern, and pretending to be a registered person by using a photograph and the like of the face of a registered person can be made difficult.

### Second Exemplary Embodiment

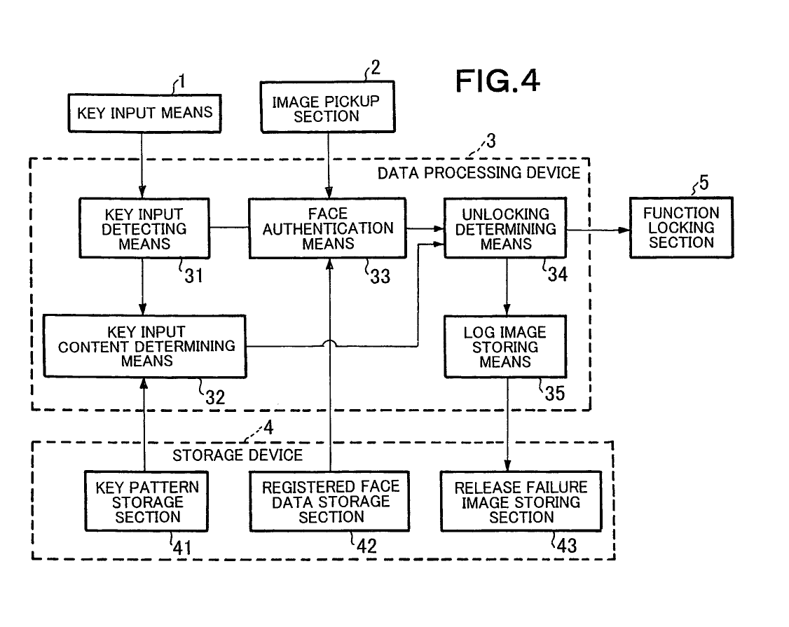

Next, a second exemplary embodiment of the present invention will be described with reference to the accompanying drawings. FIG. 4 is a block diagram showing a configuration example of the function unlocking system according to the present exemplary embodiment. The function unlocking system shown in FIG. 4 is different as compared with the first exemplary embodiment shown in FIG. 1 with respect to points that the data processing device 3 includes a log image storing means 35 and the storage device 4 includes a release failure image storage section 43.

In case the unlocking determining means 34 determines that unlocking is not permitted, the log image storing means 35 stores the image to be authenticated that is picked up by the image pickup section 2 in the release failure image storage section 43 as an unauthorized access log image. The release failure image storage section 43 may store, for example, time that authentication is carried out and a key pattern input at the time of authentication, in addition to an image picked up by the image pickup section 2. Also, in case the face authentication means 33 identifies a face area, an image obtained by cutting out only the face area, instead of an image picked up by the image pickup section 2 as it is, can also be stored as an unauthorized access log image.

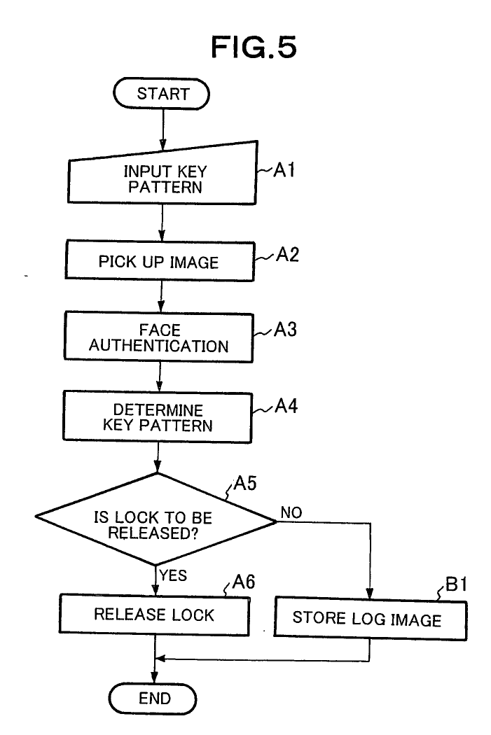

Next, description will be made with respect to operation of the present exemplary embodiment. FIG. 5 is a flowchart showing an operation example of the unlocking system according to the present exemplary embodiment. The flowchart shown in FIG. 5 is different as compared with the flowchart in the first exemplary embodiment shown in FIG. 3 with respect to operation of when unlocking is determined not to be permitted in Step A5.

As similar to the first exemplary embodiment, the unlocking determining means 34 determines whether unlocking is to be permitted or not on the basis of a result of the face authentication obtained in Step A3 and a result of the key pattern determination obtained in Step A4 (Step A5). Here, in case the unlocking determining means 34 determines that unlocking is not to be permitted (No in Step A5), the log image storing means 35 stores the image to be authenticated that is used for the determination in the release failure image storage section 43 as an unauthorized access log image (Step B1), and the processing ends. The log image storing means 35 stores, for example, an image picked up by the image pickup section 2 and information including time at which authentication is carried out and a key pattern input at the time of authentication in the release failure image storage section 43. In case unlocking is determined to be permitted, the function locking section 5 releases a lock in a similar manner as the first exemplary embodiment (Step A6).

As described above, according to the present exemplary embodiment, a picked-up image can be stored as a log image when unlocking is failed. Accordingly, the face of a person who attempted unauthorized access to an information processing terminal can be checked. In addition, with the above configuration, a deterrent effect against unauthorized access can be expected. The second exemplary embodiment is similar to the first exemplary embodiment with respect to other characteristics.

Further, in the first and the second exemplary embodiments, description is made on the basis of an example where the face authentication and the key pattern determination are combined. However, authentication systems are not limited to the above two, and three or more systems can be combined. As authentication systems to be combined, one that is accompanied by input operation by the user and one that is not accompanied by such input operation are preferably combined. However, any system may be used as long as the system starts authentication with input operation by the user as a trigger.

Authentication systems to be combined may include, for example, an acceleration information determination in which determination of an identified pattern is carried out on the basis of a way of shaking (twice to the right, and the like) a terminal which includes an acceleration sensor, in addition to face authentication and key pattern determination. Further, voice information determination in which determination of an identified pattern is carried out on the basis of, for example, a voice (“Ah”, “Ha, Ha”, or a specific sentence) may be used. In addition to the above, an authentication system that uses, for example, an iris, a fingerprint, a pattern on a skin (texture on a skin, a mole, a spot, and the like) as bio-information other than face and voice, and a system of carrying out identification determination on the basis of a degree of coincidence of a shape, a color, an image pickup direction, a size in a screen, and the like in information of an artificial object (for example, a card, a watch, and an accessory) that is carried around on a daily basis may be considered.

### Third Exemplary Embodiment

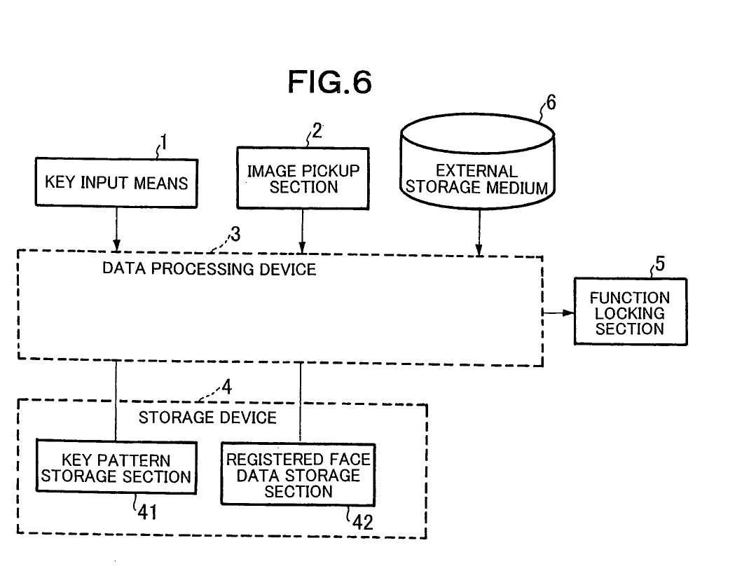

Next, a third exemplary embodiment of the present invention will be described with reference to the accompanying drawings. FIG. 6 is a block diagram showing a configuration example of the function unlocking system according to the present exemplary embodiment. The function unlocking system shown in FIG. 6 is different as compared with the first exemplary embodiment shown in FIG. 1 with respect to a point that an external storage medium 6 is added.

In the present exemplary embodiment, the external storage medium 6 includes a function unlocking program for executing processing for unlocking that is carried out by processing means, such as the key input detecting means 31 and the key input content determining means 32, that are included in the data processing device 3 in the first exemplary embodiment. The data processing device 3 carries out operation that is similar to that in the first exemplary embodiment by reading in the unlocking program stored in the external storage medium 6. Storage areas for unlocking, such as the key pattern storage section 41 and the registered face data storage section 42 included in the storage device 4 may be dynamically allocated by the data processing device 3 that has read in the function unlocking program.

The unlocking program may be a program for executing processing of unlocking that is carried out by processing means not only in the first exemplary embodiment, but also in the second exemplary embodiment. In such a case, the data processing device 3 carries out operation similar to that in the second exemplary embodiment in accordance with the read-in function unlocking program. In this case, the storage device 4 includes the release failure image storage section 43.

### EXAMPLES

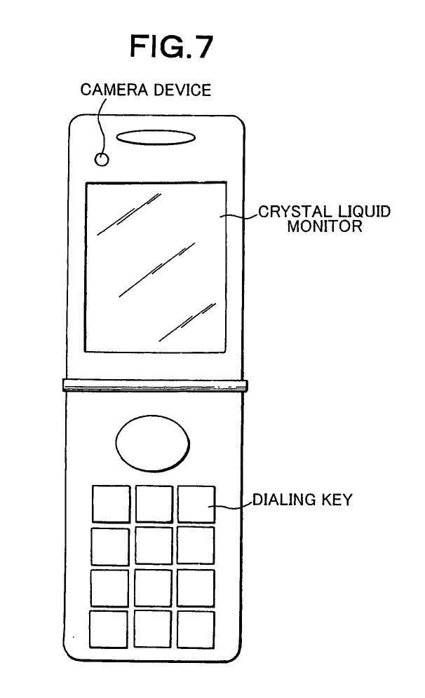

Next, description will be made with respect to operation of a best mode for performing the present invention on the basis of a specific example. The example that will be described below corresponds to the second exemplary embodiment of the present invention. FIG. 7 is an explanatory view showing a configuration example of a portable telephone device applied with the function unlocking system. As shown in FIG. 7, the present example shows an example where a camera-equipped portable phone device is used as an information processing terminal. The portable phone device in the present example includes a camera device, such as a CMOS camera and a CCD camera, as the image pickup section 2. Also, the portable phone device includes dialing keys as the key input means 1, a data processing system as the data processing device 3, and a memory as the storage device 4. In addition, the portable phone device includes an all-lock function in the inside of the data processing system as the function locking section 5. The all-lock function is used for locking all functions except for a telephone conversation function controlled by the data processing system.

The data processing system of the portable telephone device includes a central processing unit that operates as the key input detecting means 31, the key input content determining means 32, the face authentication means 33, the unlocking determining means 34, the log image storing means 35, and the function locking section 5. Also, the memory of the portable phone device stores a registered key pattern, registered face data, and an unauthorized access image log, as the key pattern storage section 41, the registered face data storage section 42, and the release failure image storage section 43.

The registered key pattern stored in the key pattern storage section 41 is a combination of, for example, a single number such as “1” and “5”, a pattern in which the same numerical value is repeated such as “11” and “55”, a numerical value such as “1234”, and an optional character sequence such as “ABCD . . . ”.

Here, in face authentication, a probability of determining a person not in an image as the person in the image in error (false acceptance rate) is assumed to be 1%, and a probability of determining the person in an image as not in the image in error (false rejection rate) is assumed to be 1%. In case unlocking is executed by using only the face authentication, the face authentication is started by detecting that the user presses a specific button (hereinafter referred to as the shutter release) for starting the face authentication. Then, determination of whether unlocking is permitted or not is carried out on the basis of a result of the face authentication. Accuracy of unlocking at this time is a false acceptance rate of 1% and a false rejection rate of 1%, as similar to the accuracy of the face authentication.

On the other hand, in the present example, the shutter button for the face authentication is registered as an optional key pattern that is designated by the user. In this manner, accuracy of unlocking is improved. For example, in case the key pattern to be the stutter release is any one key from “0” to “9”, there are 10 variations as the registered key pattern. For this reason, accuracy of unlocking after combining the face authentication and key pattern determination is a false acceptance rate of 0.1% and a false rejection rate of 1%. In this manner, a false acceptance rate can be improved, despite the fact that, from the user's point of view, work of unlocking which is pressing the shutter release for once is unchanged.

In addition, in case a pattern of pressing any key for twice repeatedly as a double click is permitted in addition to a pattern of pressing any key for once as the shutter button, there are 20 variations from “0” to “9”, and “00”, “11”, . . . , “99” as the registered key pattern. In such a case, in accuracy of unlocking combining the face authentication and key pattern determination, a false acceptance rate can be improved to 0.05%.

In consideration of convenience to the user, the registered key pattern is preferably a pattern of inputting a key for once or inputting the same key for a plurality of times. However, in case a false acceptance rate desires to be improved further, an optional character sequence, a variety of function keys, a moving direction by Neuropointer, and the like may be combined.

Operation of the present example will be as described below. As shown in FIG. 5, when an input key pattern “11” is input by the user by a double click of “1” key (Step A1), the central processing unit detects that a key pattern is input by the user, and starts and controls a camera device to pick up a face image of the user (Step A2). When the picked-up image data is input from the camera device, the central processing unit executes face authentication processing by using the input image data and the registered face data stored in the memory in advance (Step A3).

In addition, when the central processing unit detects that a key pattern is input by the user, the central processing unit executes key pattern determination processing by using an input key pattern shown by key information input by using dialing keys and the registered key pattern stored in the memory in advance (Step A4). The central processing unit identifies an input key pattern on the basis of, for example, the key information input by using the dialing keys and an input timing, and determines whether the input key pattern and the registered key pattern are the same or not in terms of a type, the number of times, the order, and a timing of keys.

When results of the face authentication processing and the key pattern determination processing show that the user and the registered person are the same and the input key pattern and the registered key pattern are the same, the central processing device releases a lock (Yes in Step A5, and Step A6), and the user is allowed to view information in the inside of the portable phone device. On the other hand, in case the user and the registered person are not the same person, or the input key pattern and the registered key pattern are not the same, or both of these apply, the face image of the user that is picked up for authentication is stored in the memory as an image of a person who attempted unauthorized access, so that the authorized user can view the image later (No in Step A5, and Step B1).

### INDUSTRIAL APPLICABILITY

The present invention can be suitably applied to a device that carries out personal authentication in a password system, an ID system using an IC card and the like, a biometrics system using bio-information, and the like.

1-16. (canceled)

17. A function unlocking system that releases a locking state which is a state where a function of an information processing terminal is locked, comprising:
an image pickup section that picks up an image of a face of a person to be authenticated;
key input means for detecting key input by the person to be authenticated;
face authentication means for starting the image pickup section when the key input is detected to pick up an image of a face of the person to be authenticated, and determining whether the person to be authenticated is a person who is permitted to use the information processing terminal or not;
pattern determining means for determining whether the key input matches with a pattern registered in advance or not; and
unlocking determining means for determining whether the locking state of the information processing terminal is to be released or not on the basis of a result of authentication by the face authentication means and a result of determination by the pattern determining means.

18. The function unlocking system according to claim 17, wherein
the face authentication means includes:
face detecting means for identifying a position of a face in an image; and
face verifying means for determining a degree of coincidence between the face data identified by the face data detecting means and face data registered in advance.

19. The function unlocking system according to claim 17, wherein
the key pattern used by the pattern determining means for determination includes a number in one digit, a character, or a function key.

20. The function unlocking system according to claim 17, wherein
the key pattern used by the pattern determining means for determination includes the same number, character, or function key that is repeated for a plurality of times.

21. The function unlocking system according to claim 17, wherein
the key pattern used by the pattern determining means for determination includes an input sequence of a number, characters, or function keys in a predetermined length.

22. A function unlocking method that releases a locking state which is a state where a function of an information processing terminal is locked, comprising:
an image pickup step of picking up an image of a face of a person to be authenticated;
a key input step of detecting key input by the person to be authenticated;
a face authentication step of starting the image pickup step when the key input is detected to pick up an image of a face of the person to be authenticated, and determining whether the person to be authenticated is a person who is permitted to use the information processing terminal or not;
a pattern determining step of determining whether the key input matches with a pattern registered in advance or not; and
a unlocking determining step of determining whether the locking state of the information processing terminal is to be released or not on the basis of a result of authentication by the face authentication step and a result of determination by the pattern determining step.

23. A computer readable medium storing a function unlocking program for releasing a locking state which is a state where a function of an information processing terminal is locked, the function unlocking program for controlling a computer to execute:
an image pickup processing for picking up an image of a face of a person to be authenticated;
a key input processing for detecting key input by the person to be authenticated;
a face authentication processing for starting the image pickup processing when the key input is detected to pick up an image of a face of the person to be authenticated, and determining whether the person to be authenticated is a person who is permitted to use the information processing terminal or not;
a pattern determining processing for determining whether the key input matches with a pattern registered in advance or not; and
a unlocking determining processing for determining whether the locking state of the information processing terminal is to be released or not on the basis of a result of authentication by the face authentication processing and a result of determination by the pattern determining processing.

24. An information processing terminal using the function unlocking system according to claim 17.

25. A portable telephone device using the function unlocking system according to claim 17.

26. The function unlocking method according to claim 22, wherein
the face authentication step includes:
a face detecting step of identifying a position of a face in an image; and
a face verifying step of determining a degree of coincidence between the face data identified by the face data detecting step and face data registered in advance.

27. The function unlocking method according to claim 22, wherein
the key pattern used by the pattern determining step for determination includes a number in one digit, a character, or a function key.

28. The function unlocking method according to claim 22, wherein
the key pattern used by the pattern determining means for determination includes the same number, character, or function key that is repeated for a plurality of times.

29. The function unlocking method according to claim 22, wherein
the key pattern used by the pattern determining step for determination includes an input sequence of a number, characters, or function keys in a predetermined length.

30. The computer readable medium according to claim 23, wherein
the face authentication processing includes:
a face detecting processing for identifying a position of a face in an image; and
a face verifying processing for determining a degree of coincidence between the face data identified by the face data detecting means and face data registered in advance.

31. The computer readable medium according to claim 23, wherein
the key pattern used by the pattern determining processing for determination includes a number in one digit, a character, or a function key.

32. The computer readable medium according to claim 23, wherein
the key pattern used by the pattern determining processing for determination includes the same number, character, or function key that is repeated for a plurality of times.

33. The computer readable medium according to claim 23, wherein
the key pattern used by the pattern determining processing for determination includes an input sequence of a number, characters, or function keys in a predetermined length.
